(19) United States
(12) Patent Application Publication
(10) Pub. No.: US 2024/0279062 A1
(43) Pub. Date: Aug. 22, 2024

(54) Method and system for efficient and selective recovery of ferric phosphate product from leachate

(71) Applicant: Peking University, Beijing (CN)

(72) Inventors: Wulin Yang, Beijing (CN); Shaogang Hu, Beijing (CN)

(73) Assignee: Peking University, Beijing (CN)

(21) Appl. No.: 18/583,390

(22) Filed: Feb. 21, 2024

(30) Foreign Application Priority Data
Feb. 21, 2023 (CN) 202310144580.0

(51) Int. Cl. C01B 25/37

(52) U.S. Cl. CPC C01B 25/375; C01P 2002/72

(57) ABSTRACT

The present disclosure provides a method and a system for efficient and selective recovery of a ferric phosphate product from a leachate. The method includes the following steps: adjusting a pH value of a phosphorus-containing leachate to obtain an acidic phosphorus-containing leachate, heating the acidic phosphorus-containing leachate, adding an iron salt to precipitate a phosphorus element in the acidic phosphorus-containing leachate in the form of a ferric phosphate hydrate, and recovering an obtained ferric phosphate hydrate precipitate. In the present disclosure, production of a phosphorus product requires a certain amount of iron element added into the leachate. Iron widely distributed on the earth is low in cost and easily available, thereby facilitating large-scale applications of the method. An initial leachate after acid leaching shows acidic, and only a slight pH adjustment is required to achieve a target pH value of the leachate.

### CROSS REFERENCE TO RELATED APPLICATION

This patent application claims the benefit and priority of Chinese Patent Application No. 202310144580.0, filed with the China National Intellectual Property Administration on Feb. 21, 2023, the disclosure of which is incorporated by reference herein in its entirety as part of the present application.

### TECHNICAL FIELD

The present disclosure belongs to the technical field of phosphorus recovery, and more specifically relates to a method and a system for efficient and selective recovery of a ferric phosphate product from a leachate.

### BACKGROUND

Currently, the global phosphorus element mainly diffuses from high-concentration phosphate rocks to low-concentration natural environments, resulting in one-way flow of phosphorus in the biosphere and non-renewable characteristics. As an indispensable nutrient for plant growth, phosphorus is critical to the development of modern agriculture. It is estimated that available global phosphate rock reserves may be exhausted within 50 to 100 years. Therefore, there is a need to search for alternative resources for the phosphate rock to meet the growing demand for phosphorus in modern agriculture.

A large amount of phosphorus consumed by human beings in daily production and life enters sewage treatment plants through urban sewage pipeline networks. 90% of the phosphorus in sewage is finally concentrated into sludge through biological phosphorus removal or chemical precipitation, making municipal sludge contain a large amount of phosphorus. Municipal sludge serves as a by-product of the sewage treatment requires appropriate disposal. Sludge incineration, as a harmless sludge treatment technology, is a sludge treatment process promoted and applied in many countries. After municipal sludge is incinerated, there is a significantly reduced sludge volume. The phosphorus in sludge is further enriched, with a phosphorus content accounting for approximately 4.9 wt % to 11.9 wt %, which is equivalent to that in low-grade phosphate rocks. At present, after global sludge is incinerated, an annual output of sludge incineration ash is approximately 1.7 million tons. It can be seen that the sludge incineration ash has a huge annual output and can be used as a substitute for phosphate rocks to meet the growing human demand for phosphorus. However, during the sludge incineration, the sludge incineration ash is also enriched with a large number of other heavy metal elements that increase the difficulty of recovering phosphorus in the sludge incineration ash. There is therefore a demand to develop various technologies to improve the purity of recovered phosphorus products.

So far, wet extraction is the mainstream technology for recovering phosphorus from sludge incineration ash. This technology is to dissolve the phosphorus in sludge incineration ash into a solution mainly using acidic reagents such as organic acids and inorganic acids, and then recover phosphorus from the solution (namely leachate). In particular, dissolving the phosphorus in sludge incineration ash into the solution using H₂SO₄ solution has a phosphorus leaching efficiency as high as 90% to 100%. However, other soluble elements and heavy metal elements in the sludge incineration ash are inevitably dissolved into the leachate during acid leaching, and greatly increase the difficulty of recovering high-purity phosphorus products from the leachate.

The researchers have found that a concentration of cationic impurities in the leachate can be reduced through ion exchange using cation exchange resin, and then NH₄⁺ and Mg²⁺ are added at a strict molar ratio while a pH of the leachate is strictly controlled to produce a high-purity struvite product. Multiple extraction process can reduce the concentration of impurity ions in the leachate through multiple extractions, thereby increasing the concentration of subsequent phosphorus products. Impurity elements in the sludge incineration ash are extracted with an ethylenediaminetetraacetic acid (EDTA) solution, the sludge incineration ash with impurity elements extracted is further leached with a H₂SO₄ solution to reduce impurity elements in the leachate, and quicklime is added to produce high-purity calcium and phosphorus products. However, phosphorus products produced by the above two technologies require additional purification to achieve the recovery of high-purity phosphorus products, making the phosphorus product recovery complex and expensive.

The researchers have also found that an adsorbent prepared based on zirconium exhibits specific adsorption of phosphorus and can selectively recover the phosphorus directly from the leachate without any purification process. However, the recovery of phosphorus products using a zirconium-based adsorbent has a complicated process, including a series of procedures such as adsorption-desorption of phosphorus and generation of phosphorus products. Moreover, there is a complicated preparation process of the zirconium-based adsorbent, and subsequent reduction of an adsorption capacity of the zirconium-based adsorbent requires a corresponding treatment, which is not conducive to large-scale applications. In view of this, there is a need to develop a process for efficient recovery of phosphorus that is simple to operate, has mild operating conditions, and shows a low economic cost.

### SUMMARY

In order to solve the deficiencies in the prior art, the present disclosure provides a method for efficient and selective recovery of a ferric phosphate product from a leachate. The method does not require additional purification, only needs to add a certain amount of iron element to the leachate, slightly adjust a pH value of the leachate to about 1.2, and then treat the leachate in a water bath at 80° C. for 30 min to produce a ferric phosphate hydrate precipitate, thereby achieving efficient recovery of phosphorus in the sludge incineration ash. The method is simple and easy to implement, and has great economic advantages and application prospects.

The present disclosure adopts the following technical solutions.

The present disclosure provides a method for efficient and selective recovery of a ferric phosphate product from a leachate, including the following steps:

adjusting a pH value of a phosphorus-containing leachate to obtain an acidic phosphorus-containing leachate, heating the acidic phosphorus-containing leachate, adding an iron salt to precipitate a phosphorus element in the acidic phosphorus-containing leachate in the form of a ferric phosphate hydrate, and recovering an obtained ferric phosphate hydrate precipitate.

Preferably, the method specifically includes: adjusting the pH value of the phosphorus-containing leachate to 1 to 2 to obtain the acidic phosphorus-containing leachate, heating the acidic phosphorus-containing leachate, controlling a temperature of the acidic phosphorus-containing leachate to a preset temperature range to allow heat preservation, adding the iron salt based on a mole of the phosphorus element to precipitate the phosphorus element in the acidic phosphorus-containing leachate in the form of the ferric phosphate hydrate, and conducting solid-liquid separation to obtain the ferric phosphate hydrate precipitate and a leachate.

Preferably, sludge incineration ash is added into the leachate after the ferric phosphate hydrate precipitate is obtained to allow first recycling of the leachate.

Preferably, the method specifically includes the following steps:
step 1: adding sludge incineration ash into a H₂SO₄ solution to obtain the phosphorus-containing leachate; and
step 2: subjecting the phosphorus-containing leachate obtained in step 1 to solid-liquid separation to obtain a residue and the leachate, adding the iron salt into the leachate, adding an acid-alkali solution to adjust a pH value of the leachate to a preset value, controlling a temperature of the leachate to a preset temperature, and recovering the ferric phosphate hydrate precipitate.

Preferably, step 1 includes:
step 1.1: incinerating municipal sludge in an incinerator to obtain the sludge incineration ash;
step 1.2: adding the sludge incineration ash into a 0.2 mol/L H₂SO₄ solution at a liquid-to-solid ratio of 50 mL:1 g, and recording a pH value of a resulting mixed solution as an initial pH value; and
step 1.3: shaking the mixed solution to allow leaching in a shaking incubator at 200 rpm for 12 h, thereby fully acid-dissolving the phosphorus element in the sludge incineration ash into the mixed solution to obtain the phosphorus-containing leachate.

Preferably, step 2 includes:
step 2.1: subjecting the phosphorus-containing leachate to solid-liquid separation to obtain a residue and a leachate;
step 2.2: measuring a concentration of the phosphorus element in the leachate, and adding the iron salt at a stoichiometric molar ratio of 1:1 based on the mole of the phosphorus element;
step 2.3: adding an acid-alkali solution to adjust a pH value of the leachate to a target pH value of 1.2 to obtain the acidic phosphorus-containing leachate, controlling a temperature of the acidic phosphorus-containing leachate to 80° C. to allow heat preservation for 30 min to precipitate the phosphorus element in the acidic phosphorus-containing leachate in the form of the ferric phosphate hydrate;
step 2.4: conducting solid-liquid separation to obtain the ferric phosphate hydrate precipitate and the leachate; and
step 2.5: drying the ferric phosphate hydrate precipitate in an oven at 70° C. for 10 h to obtain a dry ferric phosphate hydrate precipitate.

Preferably, the method further includes step 3: subjecting the leachate after the ferric phosphate hydrate precipitate is obtained in step 2 to second recycling, where the second recycling specifically includes:
adjusting the pH value of the leachate after the ferric phosphate hydrate precipitate is obtained in step 2 to the initial pH value, and adding the sludge incineration ash, thereby fully acid-dissolving the phosphorus element in the sludge incineration ash based on the process in step 1; and adding an equivalent amount of the iron salt as the iron salt in step 2 into the leachate, and recovering the ferric phosphate hydrate precipitate based on the process in step 2.

Preferably, the method further includes step 4: treating the leachate after the ferric phosphate hydrate precipitate is obtained in a water bath and recovering the phosphorus element in the form of the ferric phosphate hydrate after the phosphorus element in the leachate is initially precipitated as the ferric phosphate hydrate precipitate in step 3.

Preferably, the method further includes step 5: subjecting the leachate after the ferric phosphate hydrate precipitate is obtained in step 4 to third recycling; where during the third recycling of the leachate, a recovery process of the phosphorus element in the sludge incineration ash is consistent with a recovery process of the phosphorus element during the second recycling of the leachate, and includes steps that are consistent with steps 3 and 4;
step 6: subjecting the leachate after the ferric phosphate hydrate precipitate is obtained in step 5 to fourth recycling; where during the fourth recycling of the leachate, a recovery process of the phosphorus element in the sludge incineration ash is consistent with the recovery process in step 5; and
step 7: subjecting the leachate after the ferric phosphate hydrate precipitate is obtained twice in step 6 to fifth recycling; where during the fifth recycling of the leachate, after the phosphorus element in the sludge incineration ash is released into the leachate, the phosphorus element in the leachate is subjected to three precipitations in the form of the ferric phosphate hydrate precipitate; a first precipitation and a second precipitation of the phosphorus element in the leachate are conducted based on step 6, while a third precipitation of the phosphorus element in the leachate is conducted based on the second precipitation.

The present disclosure further provides a system for efficient and selective recovery of a ferric phosphate product from a leachate, where the system is configured to implement the method, and includes a pH value adjustment module, a temperature control module, an iron element addition module, and a recovery module that are configured to adjust the pH value of the phosphorus-containing leachate to obtain the acidic phosphorus-containing leachate, to heat the acidic phosphorus-containing leachate, to add the iron salt to precipitate the phosphorus element in the acidic phosphorus-containing leachate in the form of the ferric phosphate hydrate, and to recover the obtained ferric phosphate hydrate precipitate, respectively.

The beneficial effects of the present disclosure are that: compared with the prior art, the present disclosure proposes a method and a system that can efficiently recover phosphorus directly from the leachate. It is proposed for the first time that the phosphorus in the leachate can be directly removed from the leachate in the form of high-purity ferric phosphate hydrate by adjusting the pH value, adding the iron salt, and controlling the temperature without purification and pretreatment of the phosphorus in the leachate. Specifically, the beneficial effects are as follows:
(1) In the present disclosure, the production of high-purity ferric phosphate product is mainly achieved by adding an iron reagent to the leachate and controlling the pH and temperature of the leachate. In the method, production of a phosphorus product requires a certain amount of iron element added into the leachate. Iron widely distributed on the earth is low in cost and easily available, thereby facilitating large-scale applications of the method.
(2) An initial leachate after acid leaching shows acidic, and only a slight pH adjustment is required to achieve a target pH value of the leachate. Therefore, there is a low dosage of the acid-alkali reagent required for the leachate.
(3) In the present disclosure, the leachate needs to be controlled at 80° C. for 30 min to promote the production of ferric phosphate. The electrical energy required to control leachate temperature can be supplied by electricity generated from green energy sources such as solar energy and wind energy, and can be achieved at night when there is a low load on the grid. Therefore, there is also an economical cost of the electrical energy required by this method.
(4) After the phosphorus product is initially recovered from the leachate, the leachate still appears acidic. Accordingly, the leachate can be used as an initial acidic solution for leaching the phosphorus from sludge incineration ash next time, thereby realizing recycling of the acidic leachate (FIG. 1). During the recycling of acidic leachate, the efficiency of phosphorus recovered from the leachate gradually increases, and there is still a high purity of the recovered phosphorus product. After the leachate is recycled 5 times, a cumulative recovery efficiency of phosphorus in the leachate reaches 81.1%±1.8% (FIG. 2), while the recovered phosphorus product mainly exists in the form of a ferric phosphate hydrate (FIG. 3).

Therefore, compared with other methods for recovering phosphorus from sludge incineration ash, the method of the present disclosure is not only simple to operate under mild operating conditions, but also only requires reagents that are cheap and easily available. Moreover, there is high efficiency and purity in recovering phosphorus from the sludge incineration ash, showing relatively desirable economic advantages and market application prospects.

### BRIEF DESCRIPTION OF THE DRAWINGS

FIG. 1 shows a flow chart of the method for efficient and selective recovery of a ferric phosphate product from a leachate in the present disclosure;

FIG. 2 shows a cumulative recovery efficiency of phosphorus from sludge incineration ash in the present disclosure; and

FIG. 3 shows a phase composition of the phosphorus product recovered from sludge incineration ash after calcination in the present disclosure.

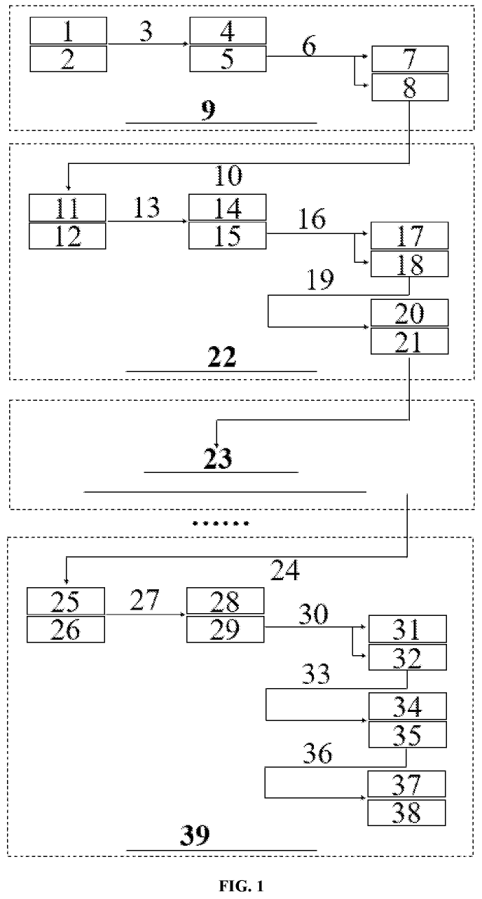

Reference numerals in FIG. 1:
1. Sulfuric acid concentration 0.2 M (initial pH value)
2. Sludge incineration ash
3. Solid-to-liquid dosage (solid-to-liquid ratio 50 mL:1 g) Shaking at 200 rpm for 12 h
4. Residue
5. Leachate
6. Initial iron dosage (iron-to-phosphorus molar ratio 1:1) pH=1.2, heat preservation at 80° C. for 30 min
7. Phosphorus recovery product
8. Leachate
9. Phosphorus product recovery during first recycling of leachate
10. Recycling of leachate Adjustment of pH value to initial pH value
11. Recycling of leachate
12. Sludge incineration ash
13. Solid-to-liquid dosage (solid-to-liquid ratio 50 mL:1 g) Shaking at 200 rpm for 12 h
14. Residue
15. Leachate
16. Iron dosage consistent with the initial iron dosage, pH=1.2, heat preservation at 80° C. for 30 min
17. Phosphorus recovery product
18. Leachate
19. pH=1.2, heat preservation at 80° C. for 30 min
20. Phosphorus recovery product
21. Leachate
22. Phosphorus product recovery during second recycling of leachate
23. Phosphorus product recovery during third and fourth recycling of leachate consistent with the phosphorus product recovery during second recycling of leachate
24. Recycling of leachate Adjustment of pH value to initial pH value
25. Recycling of leachate
26. Sludge incineration ash
27. Solid-to-liquid dosage (solid-to-liquid ratio 50 mL:1 g) Shaking at 200 rpm for 12 h
28. Residue
29. Leachate
30. Iron dosage consistent with the initial iron dosage, pH=1.2, water bathing at 80° C. for 30 min
31. Phosphorus recovery product
32. Leachate
33. pH=1.2, heat preservation at 80° C. for 30 min
34. Phosphorus recovery product
35. Leachate
36. pH=1.2, heat preservation at 80° C. for 30 min
37. Phosphorus recovery product
38. Leachate
39. Phosphorus product recovery during fifth recycling of leachate

### DETAILED DESCRIPTION OF THE EMBODIMENTS

To make the objective, technical solutions and advantages of the present disclosure clearer, the technical solutions in the present disclosure are clearly and completely described below with reference to the accompanying drawings in the present disclosure. The described embodiments are merely some rather than all of the embodiments of the present disclosure. All other embodiments obtained by those of ordinary skill in the art based on the embodiments of the present disclosure without creative efforts shall fall within the protection scope of the present disclosure.

As shown in FIG. 1, an example of the present disclosure provides a method for efficient and selective recovery of a ferric phosphate product from a leachate, including the following steps:
adjusting a pH value of a phosphorus-containing leachate to obtain an acidic phosphorus-containing leachate, heating the acidic phosphorus-containing leachate, adding an iron salt to precipitate a phosphorus element in the acidic phosphorus-containing leachate in the form of a ferric phosphate hydrate, and recovering an obtained ferric phosphate hydrate precipitate.

In a preferred but non-limiting example of the present disclosure, the method for efficient and selective recovery of a ferric phosphate product from a leachate specifically includes the following steps:
the method specifically includes: adjusting the pH value of the phosphorus-containing leachate to 1 to 2, preferably 1.2 to obtain the acidic phosphorus-containing leachate, heating the acidic phosphorus-containing leachate, controlling a temperature of the acidic phosphorus-containing leachate to a preset temperature range to allow heat preservation, adding the iron salt based on a mole of the phosphorus element to precipitate the phosphorus element in the acidic phosphorus-containing leachate in the form of the ferric phosphate hydrate, and conducting solid-liquid separation to obtain the ferric phosphate hydrate precipitate and a leachate, thereby recovering the phosphorus element in the sludge incineration ash.

In a preferred but non-limiting example of the present disclosure, the method for efficient and selective recovery of a ferric phosphate product from a leachate more specifically includes the following steps:
the method specifically includes: adjusting the pH value of the phosphorus-containing leachate to 1 to 2 to obtain the acidic phosphorus-containing leachate, heating the acidic phosphorus-containing leachate, controlling a temperature of the acidic phosphorus-containing leachate to not less than 60° C., preferably 80° C. to allow heat preservation, adding the iron salt based on a mole of the phosphorus element to precipitate the phosphorus element in the acidic phosphorus-containing leachate in the form of the ferric phosphate hydrate, and conducting solid-liquid separation to obtain the ferric phosphate hydrate precipitate and a leachate, thereby recovering the phosphorus element in the sludge incineration ash; the sludge incineration ash is added to the leachate after the ferric phosphate hydrate precipitate is obtained, and the acid-alkali solution is added to adjust the pH value of the leachate, and the leachate is recycled.

In a more preferred but non-limiting example of the present disclosure, the method for efficient and selective recovery of a ferric phosphate product from a leachate even more specifically includes the following steps:
step 1: adding sludge incineration ash into a H₂SO₄ solution to obtain the phosphorus-containing leachate; and
preferably, step 1 specifically includes:
step 1.1: incinerating municipal sludge in an incinerator at 850° C. to obtain the sludge incineration ash;
step 1.2: adding the sludge incineration ash into a 0.2 mol/L H₂SO₄ solution at a liquid-to-solid ratio of 50 mL:1 g, and recording a pH value of a resulting mixed solution as an initial pH value at this time; and
step 1.3: shaking the mixed solution to allow leaching in a shaking incubator at 200 rpm for 12 h, thus fully acid-dissolving the phosphorus element in the sludge incineration ash into the mixed solution to obtain the phosphorus-containing leachate;
step 2: subjecting the phosphorus-containing leachate obtained in step 1 to solid-liquid separation to obtain a residue and the leachate, adding the iron salt into the leachate, adding an acid-alkali solution to adjust a pH value of the leachate to a preset value, controlling a temperature of the leachate to a preset temperature, and recovering the ferric phosphate hydrate precipitate.
preferably, step 2 specifically includes:
step 2.1: subjecting the phosphorus-containing leachate to solid-liquid separation to obtain a residue and a leachate;
step 2.2: measuring a concentration of the phosphorus element in the leachate, and adding the iron salt at a stoichiometric molar ratio of 1:1 based on the mole of the phosphorus element; that is, the dosage of iron salt is roughly such that a molar ratio of iron to phosphorus at about 1:1, which is not strictly required to be 1:1 but preferably 1:1; the method emphasizes adding a certain amount of the iron salt to generate ferric phosphate;
step 2.3: adding an acid-alkali solution to adjust a pH value of the leachate to a target pH value of preferably 1.2 to obtain the acidic phosphorus-containing leachate, controlling a temperature of the acidic phosphorus-containing leachate to 80° C. to allow heat preservation for 30 min to precipitate the phosphorus element in the acidic phosphorus-containing leachate in the form of the ferric phosphate hydrate;
step 2.4: conducting solid-liquid separation to obtain the ferric phosphate hydrate precipitate and the leachate, thereby recovering the phosphorus element in the sludge incineration ash; and
step 2.5: drying the ferric phosphate hydrate precipitate in an oven at 70° C. for 10 h to obtain a dry ferric phosphate hydrate precipitate for storage.

It can be understood that even after drying in an oven at 70° C. for 10 h, the result is ferric phosphate hydrate. What is removed in the oven is water attached to a surface of the precipitate. At this time, the water in the ferric phosphate hydrate exists in the form of bound water. The bound water can be further removed after calcination at 720° C.

Steps 1 and 2 are the specific operating procedures of the phosphorus product recovery when the leachate is subjected to first recycling in the flow chart in FIG. 1.

Step 3: the leachate after the ferric phosphate hydrate precipitate is obtained in step 2 has a pH value of about 1.2, and the leachate contains a large number of hydrogen ions. In order to save acid reagent, the leachate is subjected to second recycling. This process includes: adjusting the pH value of the leachate after the ferric phosphate hydrate precipitate is obtained in step 2, and adding the sludge incineration ash, thereby fully acid-dissolving the phosphorus element in the sludge incineration ash based on the process in step 1; and adding an equivalent amount of the iron salt as the iron salt in step 2 into the leachate, and recovering the ferric phosphate hydrate precipitate based on the process in step 2, thereby completing the second recycling of the leachate.

Preferably, step 3 specifically includes:
step 3.1: adding a small amount of H₂SO₄ solution into the leachate after the ferric phosphate hydrate precipitate is obtained in step 2, and adjusting the pH value of the leachate to be consistent with the initial pH value in step 1;
step 3.2: adding the sludge incineration ash into the leachate at a liquid-to-solid ratio of 50 mL:1 g, where acid dissolution of the phosphorus element in the sludge incineration ash is consistent with that in step 1; and
step 3.3: adding an equivalent amount of the iron salt as the iron salt in step 2 into the leachate, and recovering the ferric phosphate hydrate precipitate based on the process in step 2.

Step 4: the leachate still contains large amounts of phosphorus and iron after the phosphorus element in the leachate is initially precipitated as the ferric phosphate hydrate precipitate in step 3. In order to improve the recovery efficiency of phosphorus element, it is necessary to treat the leachate in a water bath after the phosphorus element in the leachate is initially precipitated, and recover the phosphorus element in the form of the ferric phosphate hydrate.

Preferably, step 4 specifically includes: after the initial precipitation of ferric phosphate hydrate in the leachate in step 3, conducting solid-liquid separation to obtain ferric phosphate hydrate precipitate and leachate; without adding iron, controlling the leachate at 80° C. to allow heat preservation for 30 min to promote the precipitation of iron phosphate hydrate, thus improving the recovery efficiency of phosphorus element in the leachate during the second recycling of the leachate.

Steps 3 and 4 are the specific operating procedures of the phosphorus product recovery when the leachate is subjected to second recycling in the flow chart in FIG. 1.

Preferably, the method further includes step 5: subjecting the leachate after the ferric phosphate hydrate precipitate is obtained in step 4 to third recycling; where during the third recycling of the leachate, a recovery process of the phosphorus element in the sludge incineration ash is consistent with a recovery process of the phosphorus element during the second recycling of the leachate, and includes steps that are consistent with steps 3 and 4.

Preferably, the method further includes step 6: subjecting the leachate after the ferric phosphate hydrate precipitate is obtained in step 5 to fourth recycling; where during the fourth recycling of the leachate, a recovery process of the phosphorus element in the sludge incineration ash is consistent with the recovery process in step 5. Steps 5 and 6 are the specific operating procedures of the phosphorus product recovery when the leachate is subjected to third and fourth recycling in the flow chart in FIG. 1.

Preferably, the method further includes 7: subjecting the leachate after the ferric phosphate hydrate precipitate is obtained twice in step 6 to fifth recycling; where during the fifth recycling of the leachate, after the phosphorus element in the sludge incineration ash is released into the leachate, the phosphorus element in the leachate is subjected to three precipitations in the form of the ferric phosphate hydrate precipitate; a first precipitation and a second precipitation of the phosphorus element in the leachate are conducted based on step 6, while a third precipitation of the phosphorus element in the leachate is conducted based on the second precipitation. Steps 7 is the specific operating procedures of the phosphorus product recovery when the leachate is subjected to fifth recycling in the flow chart in FIG. 1.

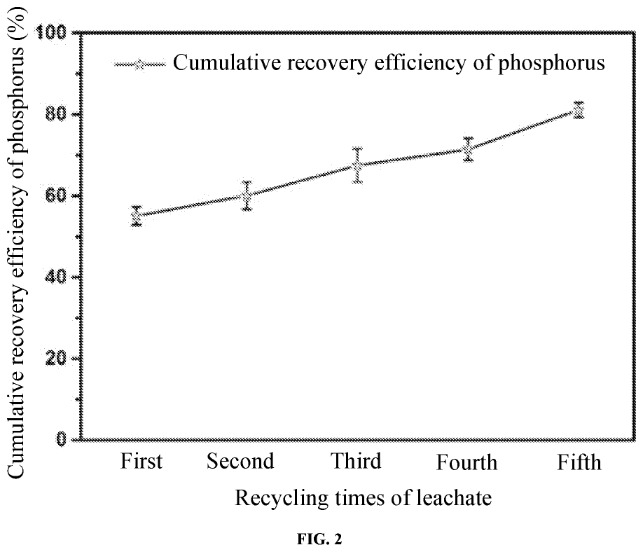

It is worth noting that in the preferred example of the present disclosure, five recycling processes serve as a preferred but non-limiting implementation means. As shown in FIG. 2, when implemented only once, the recycling efficiency of the present disclosure has reached about 55.0%±2.2%. Multiple recycling can improve the cumulative recycling efficiency. That is to say, in order to achieve the preset cumulative recycling efficiency, those skilled in the art can make a trade-off on the number of recycling times, and any number of recycling times falls within the scope of the core concept of the present disclosure.

It is also worth noting that a certain amount of ferric phosphate can be recovered from the leachate by heating the leachate, adjusting to a pH value of 1 to 2, and adding the iron salt.

The seven steps of phosphorus recovery in the specific example are the preferred specific operating conditions for the present disclosure. A core idea of the present disclosure is to heat the leachate, adjust the pH value of the leachate, and add the iron salt into the leachate.

Satisfying the above conditions and then recovering the ferric phosphate hydrate precipitate from the leachate is within the scope of the present disclosure.

An example of the present disclosure further provides a system for efficient and selective recovery of a ferric phosphate product from a leachate, where the system is configured to implement the method, and includes a pH value adjustment module, a temperature control module, an iron element addition module, and a recovery module that are configured to adjust the pH value of the phosphorus-containing leachate to obtain the acidic phosphorus-containing leachate, to heat the acidic phosphorus-containing leachate, to add the iron salt to precipitate the phosphorus element in the acidic phosphorus-containing leachate in the form of the ferric phosphate hydrate, and to recover the obtained ferric phosphate hydrate precipitate, respectively.

The beneficial effects of the present disclosure are that: compared with the prior art, the production of high-purity ferric phosphate product is mainly achieved by adding an iron reagent to the leachate and controlling the pH and temperature of the leachate. In the method, production of a phosphorus product requires a certain amount of iron element added into the leachate. Iron widely distributed on the earth is low in cost and easily available, thereby facilitating large-scale applications of the method. An initial leachate after acid leaching shows acidic, and only a slight pH adjustment is required to achieve a pH value of about 1.2 of the leachate. Therefore, there is a low dosage of the acid-alkali reagent required for the leachate.

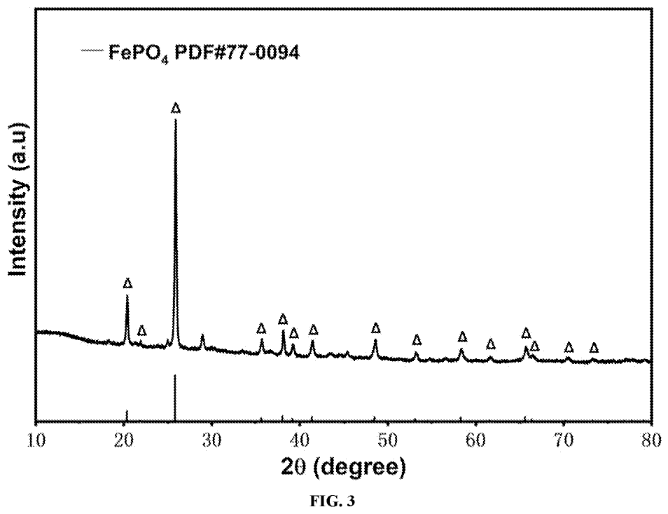

The leachate needs to be controlled at 80° C. for 30 min to promote the production of ferric phosphate. The electrical energy required to control leachate temperature can be supplied by electricity generated from green energy sources such as solar energy and wind energy, and can be achieved at night when there is a low load on the grid. Therefore, there is also an economical cost of the electrical energy required by this method. After the phosphorus product is initially recovered from the leachate by the method, the leachate still appears acidic. Accordingly, the leachate can be used as an initial acidic solution for leaching the phosphorus from sludge incineration ash next time, thereby realizing recycling of the acidic leachate (FIG. 1). During the recycling of acidic leachate, the efficiency of phosphorus recovered from the leachate gradually increases, and there is still a high purity of the recovered phosphorus product. After the leachate is recycled 5 times, a cumulative recovery efficiency of phosphorus in the leachate reaches 81.1%±1.8% (FIG. 2), while the recovered phosphorus product mainly exists in the form of a ferric phosphate hydrate, and the precipitate after calcination to remove moisture is mainly ferric phosphate (FIG. 3). In summary, compared with other methods for recovering phosphorus from sludge incineration ash, the method of the Method is not only simple to operate under mild operating conditions, but also only requires reagents that are cheap and easily available. Moreover, there is high efficiency and purity in recovering phosphorus from the sludge incineration ash, showing relatively desirable economic advantages and market application prospects.

The present disclosure may be a system, method, and/or computer program product. The computer program product may include a computer-readable storage medium storing computer-readable program instructions for enabling a processor to implement various aspects of the present disclosure.

The computer-readable storage medium may be a tangible device that can hold and store instructions used by an instruction execution device. The computer-readable storage medium may be, for example, but not limited to, an electrical storage device, a magnetic storage device, an optical storage device, an electromagnetic storage device, a semiconductor storage device, or any suitable combination of the foregoing devices. More specific examples (non-exhaustive list) of computer-readable storage media include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a protruding structure in a punched card or a groove having instructions stored thereon, and any suitable combination thereof. The computer-readable storage medium herein is not interpreted as a transient signal, such as radio waves or other freely propagating electromagnetic waves, electromagnetic waves propagating through waveguides or other transmission media (for example, light pulses through fiber optic cables), or electrical signals propagating through wires.

The computer-readable program instructions described herein can be downloaded from the computer-readable storage medium to various computing/processing devices, or downloaded to an external computer or external storage device over a network, such as the Internet, a local area network, a wide area network, and/or a wireless network. The network may include a copper transmission cable, optical fiber transmission, wireless transmission, a router, a firewall, a switch, a gateway computer, and/or an edge server. The network adapter card or network interface in each computing/processing device receives the computer-readable program instructions from the network, and forwards the computer-readable program instructions for storage in the computer-readable storage medium in each computing/processing device.

The computer program instructions used to perform the operations of the present disclosure may be assembly instructions, instruction set architecture (ISA) instructions, machine instructions, machine-dependent instructions, microcode, firmware instructions, status setting data, or source code or object code written in any combination of one or more programming languages. The programming languages include object-oriented programming languages such as Smalltalk, C++, etc., and conventional procedural programming languages such as the “C” language or similar programming languages. The computer-readable program instructions can be executed fully on a user computer, executed partially on a user computer, executed as an independent software package, executed partially on a user computer and partially on a remote computer, or executed fully on a remote computer or a server. In a circumstance in which a remote computer is involved, the remote computer may be connected to a user computer via any type of network, including a local area network (LAN) or a wide area network (WAN), or may be connected to an external computer (for example, connected via the Internet by using an Internet service provider). In some embodiments, an electronic circuit, such as a programmable logic circuit, a field-programmable gate array (FPGA), or a programmable logic array (PLA), may be customized by using status information of the computer-readable program instructions, and the electronic circuit may execute the computer-readable program instructions, thereby implementing various aspects of the present disclosure.

Finally, it should be noted that the above embodiments are merely intended to describe, rather than to limit, the technical solutions of the present disclosure. Although the present disclosure is described in detail with reference to the above embodiments, it is to be appreciated by a person of ordinary skill in the art that modifications or equivalent substitutions may still be made to the specific implementations of the present disclosure, and any modifications or equivalent substitutions made without departing from the spirit and scope of the present disclosure shall fall within the protection scope of the claims of the present disclosure.

What is claimed is:

1. A method for efficient and selective recovery of a ferric phosphate product from a leachate, comprising the following steps:
adjusting a pH value of a phosphorus-containing leachate to obtain an acidic phosphorus-containing leachate, heating the acidic phosphorus-containing leachate, adding an iron salt to precipitate a phosphorus element in the acidic phosphorus-containing leachate in the form of a ferric phosphate hydrate, and recovering an obtained ferric phosphate hydrate precipitate.

2. The method for efficient and selective recovery of a ferric phosphate product from a leachate according to claim 1, wherein:
the method specifically comprises: adjusting the pH value of the phosphorus-containing leachate to 1 to 2 to obtain the acidic phosphorus-containing leachate, heating the acidic phosphorus-containing leachate, controlling a temperature of the acidic phosphorus-containing leachate to a preset temperature range to allow heat preservation, adding the iron salt based on a mole of the phosphorus element to precipitate the phosphorus element in the acidic phosphorus-containing leachate in the form of the ferric phosphate hydrate, and conducting solid-liquid separation to obtain the ferric phosphate hydrate precipitate and a leachate.

3. The method for efficient and selective recovery of a ferric phosphate product from a leachate according to claim 2, wherein:
sludge incineration ash is added into the leachate after the ferric phosphate hydrate precipitate is obtained to allow first recycling of the leachate.

4. The method for efficient and selective recovery of a ferric phosphate product from a leachate according to claim 1, specifically comprising the following steps:
step 1: adding sludge incineration ash into a H₂SO ₄solution to obtain the phosphorus-containing leachate; and
step 2: subjecting the phosphorus-containing leachate obtained in step 1 to solid-liquid separation to obtain a residue and the leachate, adding the iron salt into the leachate, adding an acid-alkali solution to adjust a pH value of the leachate to a preset value, controlling a temperature of the leachate to a preset temperature, and recovering the ferric phosphate hydrate precipitate.

5. The method for efficient and selective recovery of a ferric phosphate product from a leachate according to claim 4, wherein:
step 1 comprises the following substeps:
step 1.1: incinerating municipal sludge in an incinerator to obtain the sludge incineration ash;
step 1.2: adding the sludge incineration ash into a 0.2 mol/L H₂SO₄ solution at a liquid-to-solid ratio of 50 mL:1 g, and recording a pH value of a resulting mixed solution as an initial pH value; and
step 1.3: shaking the mixed solution to allow leaching in a shaking incubator at 200 rpm for 12 h, thereby fully acid-dissolving the phosphorus element in the sludge incineration ash into the mixed solution to obtain the phosphorus-containing leachate.

6. The method for efficient and selective recovery of a ferric phosphate product from a leachate according to claim 5, wherein:
step 2 comprises the following substeps:
step 2.1: subjecting the phosphorus-containing leachate to solid-liquid separation to obtain a residue and a leachate;
step 2.2: measuring a concentration of the phosphorus element in the leachate, and adding the iron salt at a stoichiometric molar ratio of 1:1 based on the mole of the phosphorus element;
step 2.3: adding an acid-alkali solution to adjust a pH value of the leachate to a target pH value of 1.2 to obtain the acidic phosphorus-containing leachate, controlling a temperature of the acidic phosphorus-containing leachate to 80° C. to allow heat preservation for 30 min to precipitate the phosphorus element in the acidic phosphorus-containing leachate in the form of the ferric phosphate hydrate;
step 2.4: conducting solid-liquid separation to obtain the ferric phosphate hydrate precipitate and the leachate; and
step 2.5: drying the ferric phosphate hydrate precipitate in an oven at 70° C. for 10 h to obtain a dry ferric phosphate hydrate precipitate.

7. The method for efficient and selective recovery of a ferric phosphate product from a leachate according to claim 5, wherein:
the method further comprises step 3: subjecting the leachate after the ferric phosphate hydrate precipitate is obtained in step 2 to second recycling, wherein the second recycling specifically comprises:
adjusting the pH value of the leachate after the ferric phosphate hydrate precipitate is obtained in step 2 to the initial pH value, and adding the sludge incineration ash, thereby fully acid-dissolving the phosphorus element in the sludge incineration ash based on the process in step 1; and adding an equivalent amount of the iron salt as the iron salt in step 2 into the leachate, and recovering the ferric phosphate hydrate precipitate based on the process in step 2.

8. The method for efficient and selective recovery of a ferric phosphate product from a leachate according to claim 6, wherein:
the method further comprises step 3: subjecting the leachate after the ferric phosphate hydrate precipitate is obtained in step 2 to second recycling, wherein the second recycling specifically comprises:
adjusting the pH value of the leachate after the ferric phosphate hydrate precipitate is obtained in step 2 to the initial pH value, and adding the sludge incineration ash, thereby fully acid-dissolving the phosphorus element in the sludge incineration ash based on the process in step 1; and adding an equivalent amount of the iron salt as the iron salt in step 2 into the leachate, and recovering the ferric phosphate hydrate precipitate based on the process in step 2.

9. The method for efficient and selective recovery of a ferric phosphate product from a leachate according to claim 7, wherein:
the method further comprises step 4: treating the leachate after the ferric phosphate hydrate precipitate is obtained in a water bath and recovering the phosphorus element in the form of the ferric phosphate hydrate after the phosphorus element in the leachate is initially precipitated as the ferric phosphate hydrate precipitate in step 3.

10. The method for efficient and selective recovery of a ferric phosphate product from a leachate according to claim 8, wherein:
the method further comprises step 4: treating the leachate after the ferric phosphate hydrate precipitate is obtained in a water bath and recovering the phosphorus element in the form of the ferric phosphate hydrate after the phosphorus element in the leachate is initially precipitated as the ferric phosphate hydrate precipitate in step 3.

11. The method for efficient and selective recovery of a ferric phosphate product from a leachate according to claim 9, wherein:
the method further comprises step 5: subjecting the leachate after the ferric phosphate hydrate precipitate is obtained in step 4 to third recycling; wherein during the third recycling of the leachate, a recovery process of the phosphorus element in the sludge incineration ash is consistent with a recovery process of the phosphorus element during the second recycling of the leachate, and comprises steps that are consistent with steps 3 and 4;
step 6: subjecting the leachate after the ferric phosphate hydrate precipitate is obtained in step 5 to fourth recycling; wherein during the fourth recycling of the leachate, a recovery process of the phosphorus element in the sludge incineration ash is consistent with the recovery process in step 5; and
step 7: subjecting the leachate after the ferric phosphate hydrate precipitate is obtained twice in step 6 to fifth recycling; wherein during the fifth recycling of the leachate, after the phosphorus element in the sludge incineration ash is released into the leachate, the phosphorus element in the leachate is subjected to three precipitations in the form of the ferric phosphate hydrate precipitate; a first precipitation and a second precipitation of the phosphorus element in the leachate are conducted based on step 6, while a third precipitation of the phosphorus element in the leachate is conducted based on the second precipitation.

12. The method for efficient and selective recovery of a ferric phosphate product from a leachate according to claim 10, wherein:
the method further comprises step 5: subjecting the leachate after the ferric phosphate hydrate precipitate is obtained in step 4 to third recycling; wherein during the third recycling of the leachate, a recovery process of the phosphorus element in the sludge incineration ash is consistent with a recovery process of the phosphorus element during the second recycling of the leachate, and comprises steps that are consistent with steps 3 and 4;
step 6: subjecting the leachate after the ferric phosphate hydrate precipitate is obtained in step 5 to fourth recycling; wherein during the fourth recycling of the leachate, a recovery process of the phosphorus element in the sludge incineration ash is consistent with the recovery process in step 5; and
step 7: subjecting the leachate after the ferric phosphate hydrate precipitate is obtained twice in step 6 to fifth recycling; wherein during the fifth recycling of the leachate, after the phosphorus element in the sludge incineration ash is released into the leachate, the phosphorus element in the leachate is subjected to three precipitations in the form of the ferric phosphate hydrate precipitate; a first precipitation and a second precipitation of the phosphorus element in the leachate are conducted based on step 6, while a third precipitation of the phosphorus element in the leachate is conducted based on the second precipitation.

13. A system for efficient and selective recovery of a ferric phosphate product from a leachate, wherein the system is configured to implement the method according to claim 1, and comprises a pH value adjustment module, a temperature control module, an iron element addition module, and a recovery module that are configured to adjust the pH value of the phosphorus-containing leachate to obtain the acidic phosphorus-containing leachate, to heat the acidic phosphorus-containing leachate, to add the iron salt to precipitate the phosphorus element in the acidic phosphorus-containing leachate in the form of the ferric phosphate hydrate, and to recover the obtained ferric phosphate hydrate precipitate, respectively.

14. The system according to claim 13, wherein:
the method specifically comprises: adjusting the pH value of the phosphorus-containing leachate to 1 to 2 to obtain the acidic phosphorus-containing leachate, heating the acidic phosphorus-containing leachate, controlling a temperature of the acidic phosphorus-containing leachate to a preset temperature range to allow heat preservation, adding the iron salt based on a mole of the phosphorus element to precipitate the phosphorus element in the acidic phosphorus-containing leachate in the form of the ferric phosphate hydrate, and conducting solid-liquid separation to obtain the ferric phosphate hydrate precipitate and a leachate.

15. The system according to claim 14, wherein:
sludge incineration ash is added into the leachate after the ferric phosphate hydrate precipitate is obtained to allow first recycling of the leachate.

16. The system according to claim 13, specifically comprising the following steps:
step 1: adding sludge incineration ash into a H₂SO₄ solution to obtain the phosphorus-containing leachate; and
step 2: subjecting the phosphorus-containing leachate obtained in step 1 to solid-liquid separation to obtain a residue and the leachate, adding the iron salt into the leachate, adding an acid-alkali solution to adjust a pH value of the leachate to a preset value, controlling a temperature of the leachate to a preset temperature, and recovering the ferric phosphate hydrate precipitate.

17. The system according to claim 16, wherein:
step 1 comprises the following substeps:
step 1.1: incinerating municipal sludge in an incinerator to obtain the sludge incineration ash;
step 1.2: adding the sludge incineration ash into a 0.2 mol/L H₂SO₄ solution at a liquid-to-solid ratio of 50 mL:1 g, and recording a pH value of a resulting mixed solution as an initial pH value; and
step 1.3: shaking the mixed solution to allow leaching in a shaking incubator at 200 rpm for 12 h, thereby fully acid-dissolving the phosphorus element in the sludge incineration ash into the mixed solution to obtain the phosphorus-containing leachate.

18. The system according to claim 17, wherein:
step 2 comprises the following substeps:
step 2.1: subjecting the phosphorus-containing leachate to solid-liquid separation to obtain a residue and a leachate;
step 2.2: measuring a concentration of the phosphorus element in the leachate, and adding the iron salt at a stoichiometric molar ratio of 1:1 based on the mole of the phosphorus element;
step 2.3: adding an acid-alkali solution to adjust a pH value of the leachate to a target pH value of 1.2 to obtain the acidic phosphorus-containing leachate, controlling a temperature of the acidic phosphorus-containing leachate to 80° C. to allow heat preservation for 30 min to precipitate the phosphorus element in the acidic phosphorus-containing leachate in the form of the ferric phosphate hydrate;
step 2.4: conducting solid-liquid separation to obtain the ferric phosphate hydrate precipitate and the leachate; and
step 2.5: drying the ferric phosphate hydrate precipitate in an oven at 70° C. for 10 h to obtain a dry ferric phosphate hydrate precipitate.

19. The system according to claim 17, wherein:
the method further comprises step 3: subjecting the leachate after the ferric phosphate hydrate precipitate is obtained in step 2 to second recycling, wherein the second recycling specifically comprises:
adjusting the pH value of the leachate after the ferric phosphate hydrate precipitate is obtained in step 2 to the initial pH value, and adding the sludge incineration ash, thereby fully acid-dissolving the phosphorus element in the sludge incineration ash based on the process in step 1; and adding an equivalent amount of the iron salt as the iron salt in step 2 into the leachate, and recovering the ferric phosphate hydrate precipitate based on the process in step 2.

20. The system according to claim 19, wherein:
the method further comprises step 4: treating the leachate after the ferric phosphate hydrate precipitate is obtained in a water bath and recovering the phosphorus element in the form of the ferric phosphate hydrate after the phosphorus element in the leachate is initially precipitated as the ferric phosphate hydrate precipitate in step 3.
